(19) United States
(12) Patent Application Publication
(10) Pub. No.: US 2014/0043491 A1
(43) Pub. Date: Feb. 13, 2014

(54) METHODS AND APPARATUSES FOR DETECTION OF ANOMALIES USING COMPRESSIVE MEASUREMENTS

(71) Applicants: Hong JIANG, Warren, NJ (US); Paul WILFORD, Bernardsville, NJ (US); Gang HUANG, Monroe Township, NJ (US); Raziel HAIMI-COHEN, Springfield, NJ (US)

(72) Inventors: Hong JIANG, Warren, NJ (US); Paul WILFORD, Bernardsville, NJ (US); Gang HUANG, Monroe Township, NJ (US); Raziel HAIMI-COHEN, Springfield, NJ (US)

(73) Assignee: ALCATEL-LUCENT USA INC., Murray Hill, NJ (US)

(21) Appl. No.: 13/569,548

(22) Filed: Aug. 8, 2012

(51) Int. Cl. H04N 17/00

(52) U.S. Cl. 348/180; 348/E17.001

(57) ABSTRACT

A method for detection of anomalies using compressive measurements includes receiving sets of measurements, a set of measurements representing compressed coded data of a segment of data; collecting at least one statistic of the sets of measurements; and examining the at least one statistic to detect at least one anomaly in the at least one segment.

### BACKGROUND

Conventional surveillance systems involve a relatively large amount of video data stemming from the amount of time spent monitoring a particular place or location and the number of cameras used in the surveillance system. However, among the vast amounts of captured video data, the detection of anomalies/foreign objects is of prime interest. As such, there may be a relatively large amount of video data that will be unused.

In most conventional surveillance systems, the video from a camera is not encoded. As a result, these conventional systems have a large bandwidth requirement, as well as high power consumption for wireless cameras. In other types of conventional surveillance systems, the video from a camera is encoded using Motion JPEG, MPEG/H.264. However, this type of encoding involves high complexity and/or high power consumption for wireless cameras.

Further, conventional surveillance systems rely upon background subtraction methods to detect anomalies in the video data. If a conventional decoder receives encoded data from the cameras in the system, the decoder must first reconstruct each pixel before the conventional decoder is able to perform the background subtraction methods. However, such reconstruction adds considerably to the time and processing power required of the conventional decoder.

### SUMMARY

Embodiments relate to a method and/or apparatus for detecting anomalies in data of a communication network.

According to at least one example embodiment, a method may include receiving sets of measurements, a set of measurements representing compressed coded data of a segment of data; collecting at least one statistic of the sets of measurements; and examining the at least one statistic to detect at least one anomaly in the at least one segment.

The compressed coded data may be generated by applying sensing matrices to a segment of video data.

The collecting may include determining statistical variances of the sets of measurements, and the examining may include identifying an anomaly in the at least one segment if the statistical variance corresponding to the set of measurements representing the at least one segment differs by at least a threshold amount from a statistical variance of a set of measurements representing a segment adjacent to the at least one segment.

The method may further include determining a second statistic correlating (i) a variance of a set of measurements corresponding to a first segment or a first set of segments and (ii) a variance of a set of measurements corresponding to a second segment or a second set of segments, the second segment or second set of segments being prior in time to the first segment or the first set of segments, respectively; and indicating an error condition if the second statistic falls below a threshold.

The collecting may include arranging the received sets of measurements as a curve on at least two axes such that a first axis of the at least two axes corresponds to one of three dimensions of the data and a second axis of the at least two axes corresponds to one of three dimensions of the data different from the dimension represented by the first axis, the three dimensions being a horizontal direction, a vertical direction, and time, and determining a most likely orientation of the data in the measurement space based on statistical correlation values of the measurements. The examining may include identifying a slope of the curve, determining a speed of the point based on the slope of the curve, and identifying an anomaly if the determined speed is greater than or less than a threshold.

According to at least one example embodiment, a method may include compressing data into a set of encoded measurements; collecting at least one statistic of the set of measurements; and examining the at least one statistic to detect at least one anomaly.

The compressing may include applying sensing matrices to segments of pixels of video data.

The method may include transmitting a report of the detected at least one anomaly.

The collecting may include determining statistical variances of the sets of measurements, and the examining may include identifying an anomaly in the at least one segment if the statistical variance corresponding to the set of measurements representing the at least one segment differs by at least a threshold amount from a statistical variance of a set of measurements representing a segment adjacent to the at least one segment.

The method may further include determining a second statistic correlating a variance of a set of measurements corresponding to a first segment or a first set of segments and a variance of a set of measurements corresponding to a second segment or a second set of segments, the second segment or second set of segments being prior in time to the first segment or the first set of segments, respectively; and indicating an error condition if the second statistic falls below a threshold.

The collecting may include arranging the received sets of measurements as a curve on at least two axes such that a first axis of the at least two axes corresponds to one of three dimensions of the data and a second axis of the at least two axes corresponds to one of three dimensions of the data different from the dimension represented by the first axis, the three dimensions being a horizontal direction, a vertical direction, and time, and determining a most likely orientation of the data in the measurement space based on statistical correlation values of the measurements. The examining may include identifying a slope of the curve; determining a speed of the point based on the slope of the curve; and identifying an anomaly if the determined speed is greater than or less than a threshold.

According to at least one example embodiment, an apparatus may include a memory; a processor configured to, receive sets of measurements, a set of measurements representing compressed coded data of at least one segment of data, store the received sets of measurements in the memory, collect at least one statistic of the sets of measurements, and examine the at least one statistic to detect at least one anomaly in the at least one segment.

The compressed coded data may be generated by applying sensing matrices to a segment of video data.

The processor may be further configured to determine statistical variances of the sets of measurements; and identify an anomaly in the at least one segment if the statistical variance corresponding to the set of measurements representing the at least one segment differs by at least a threshold amount from a statistical variance of a set of measurements representing a segment adjacent to the at least one segment.

The processor may be further configured to determine a second statistic correlating (i) a variance of a set of measurements corresponding to a first segment or a first set of segments and (ii) a variance of a set of measurements corresponding to a second segment or a second set of segments, the second segment or second set of segments being prior in time to the first segment or the first set of segments, respectively; and indicate an error condition if the second statistic falls below a threshold.

The processor may be further configured to arrange the received sets of measurements as a curve on at least two axes such that a first axis of the at least two axes corresponds to one of three dimensions of the data and a second axis of the at least two axes corresponds to one of three dimensions of the data different from the dimension represented by the first axis, the three dimensions being a horizontal direction, a vertical direction, and time; determine a most likely orientation of the data in the measurement space based on statistical correlation values of the measurements; identify a slope of the curve; determine a speed of a point in a frame based on a slope of the curve; and identify an anomaly if the determined speed is greater than or less than a threshold.

According to at least one example embodiment, an apparatus may include a processor, the processor being configured to, compress data into a set of encoded measurements, collect at least one statistic of the set of measurements; and examine the at least one statistic to detect at least one anomaly.

The processor may be further configured to apply sensing matrices to a segment of video data.

The processor may be further configured to transmit a report of the detected at least one anomaly.

The processor may be further configured to determine statistical variances of the sets of measurements; and identify an anomaly in the at least one segment if the statistical variance corresponding to the set of measurements representing the at least one frame differs by at least a threshold amount from a statistical variance of a set of measurements representing a frame adjacent to the at least one frame.

The processor may be further configured to determine a second statistic correlating a variance of a set of measurements corresponding to a first segment or a first set of segments and a variance of a set of measurements corresponding to a second segment or a second set of segments, the second segment or second set of segments being prior in time to the first segment or the first set of segments, respectively; and indicate an error condition if the second statistic falls below a threshold.

The data may be video data, and the processor may be further configured to arrange the received sets of measurements as a curve on at least two axes such that a first axis of the at least two axes corresponds to one of three dimensions of the data and a second axis of the at least two axes corresponds to one of three dimensions of the data different from the dimension represented by the first axis, the three dimensions being a horizontal direction, a vertical direction, and time; determine a most likely orientation of the data in the measurement spaced on statistical correlation values of the measurements; identify a slope of the curve; determine a speed of the point based on the slope of the curve; and identify an anomaly if the determined speed is greater than or less than a threshold.

### BRIEF DESCRIPTION OF THE DRAWINGS

Example embodiments will become more fully understood from the detailed description given herein below and the accompanying drawings, wherein like elements are represented by like reference numerals, which are given by way of illustration only and thus are not limiting of the present disclosure, and wherein:

FIG. 1 illustrates a communication network according to an embodiment;

FIG. 2 illustrates components of a camera assembly and a processing unit according to an embodiment;

FIG. 3 illustrates a method of detecting anomalies in video data according to an embodiment;

FIGS. 4-5 and 6A-6B illustrate statistic collections according to embodiments; and

FIG. 7 illustrates a method of detecting anomalies in video data according to an embodiment.

### DETAILED DESCRIPTION OF EXAMPLE EMBODIMENTS

Various embodiments of the present disclosure will now be described more fully with reference to the accompanying drawings. Like elements on the drawings are labeled by like reference numerals.

Detailed illustrative embodiments are disclosed herein. However, specific structural and functional details disclosed herein are merely representative for purposes of describing example embodiments. This invention may, however, be embodied in many alternate forms and should not be construed as limited to only the embodiments set forth herein.

Accordingly, while example embodiments are capable of various modifications and alternative forms, the embodiments are shown by way of example in the drawings and will be described herein in detail. It should be understood, however, that there is no intent to limit example embodiments to the particular forms disclosed. On the contrary, example embodiments are to cover all modifications, equivalents, and alternatives falling within the scope of this disclosure. Like numbers refer to like elements throughout the description of the figures.

Although the terms first, second, etc. may be used herein to describe various elements, these elements should not be limited by these terms. These terms are only used to distinguish one element from another. For example, a first element could be termed a second element, and similarly, a second element could be termed a first element, without departing from the scope of this disclosure. As used herein, the term “and/or,” includes any and all combinations of one or more of the associated listed items.

When an element is referred to as being “connected,” or “coupled,” to another element, it can be directly connected or coupled to the other element or intervening elements may be present. By contrast, when an element is referred to as being “directly connected,” or “directly coupled,” to another element, there are no intervening elements present. Other words used to describe the relationship between elements should be interpreted in a like fashion (e.g., “between,” versus “directly between,” “adjacent,” versus “directly adjacent,” etc.).

The terminology used herein is for the purpose of describing particular embodiments only and is not intended to be limiting. As used herein, the singular forms “a”, “an”, and “the” are intended to include the plural forms as well, unless the context clearly indicates otherwise. It will be further understood that the terms “comprises”, “comprising,” “includes” and/or “including,” when used herein, specify the presence of stated features, integers, steps, operations, elements, and/or components, but do not preclude the presence or addition of one or more other features, integers, steps, operations, elements, components, and/or groups thereof.

It should also be noted that in some alternative implementations, the functions/acts noted may occur out of the order noted in the figures. For example, two figures shown in succession may in fact be executed substantially concurrently or may sometimes be executed in the reverse order, depending upon the functionality/acts involved.

Specific details are provided in the following description to provide a thorough understanding of example embodiments. However, it will be understood by one of ordinary skill in the art that example embodiments may be practiced without these specific details. For example, systems may be shown in block diagrams so as not to obscure the example embodiments in unnecessary detail. In other instances, well-known processes, structures and techniques may be shown without unnecessary detail in order to avoid obscuring example embodiments.

In the following description, illustrative embodiments will be described with reference to acts and symbolic representations of operations (e.g., in the form of flow charts, flow diagrams, data flow diagrams, structure diagrams, block diagrams, etc.) that may be implemented as program modules or functional processes include routines, programs, objects, components, data structures, etc., that perform particular tasks or implement particular abstract data types and may be implemented using existing hardware at existing network elements. Such existing hardware may include one or more Central Processing Units (CPUs), digital signal processors (DSPs), application-specific-integrated-circuits, field programmable gate arrays (FPGAs), computers or the like.

Although a flow chart may describe the operations as a sequential process, many of the operations may be performed in parallel, concurrently or simultaneously. In addition, the order of the operations may be re-arranged. A process may be terminated when its operations are completed, but may also have additional steps not included in the figure. A process may correspond to a method, function, procedure, subroutine, subprogram, etc. When a process corresponds to a function, its termination may correspond to a return of the function to the calling function or the main function.

As disclosed herein, the term “storage medium” or “computer readable storage medium” may represent one or more devices for storing data, including read only memory (ROM), random access memory (RAM), magnetic RAM, core memory, magnetic disk storage mediums, optical storage mediums, flash memory devices and/or other tangible machine readable mediums for storing information. The term “computer-readable medium” may include, but is not limited to, portable or fixed storage devices, optical storage devices, and various other mediums capable of storing, containing or carrying instruction(s) and/or data.

Furthermore, example embodiments may be implemented by hardware, software, firmware, middleware, microcode, hardware description languages, or any combination thereof. When implemented in software, firmware, middleware, or microcode, the program code or code segments to perform the necessary tasks may be stored in a machine or computer readable medium such as a computer readable storage medium. When implemented in software, a processor or processors will perform the necessary tasks.

A code segment may represent a procedure, function, subprogram, program, routine, subroutine, module, software package, class, or any combination of instructions, data structures or program statements. A code segment may be coupled to another code segment or a hardware circuit by passing and/or receiving information, data, arguments, parameters or memory contents. Information, arguments, parameters, data, etc. may be passed, forwarded, or transmitted via any suitable means including memory sharing, message passing, token passing, network transmission, etc.

In surveillance, anomalies are detected in data captured by instruments in a communications network. For example, anomalies may be detected in scenes of video captured by surveillance cameras in a surveillance camera network. An anomaly may be, for example, an intruding object in a still scene, an object moving in an opposite direction of the traffic, or an object moving too fast or too slowly. Anomaly detection may result in triggering of an alarm to, for example notify authorities to send a person to the site of the anomaly. It may be important to detect anomalies as soon as possible after they have occurred, and/or to detect anomalies while using a minimum of data.

A surveillance system typically includes a large number of surveillance cameras that are connected to a control center by a communication network. Because of the large amounts of data that may be involved, it may be desirable to keep data transmission between cameras and the control center to a minimum. In this regard, transmission of raw surveillance video pixel data may be impractical.

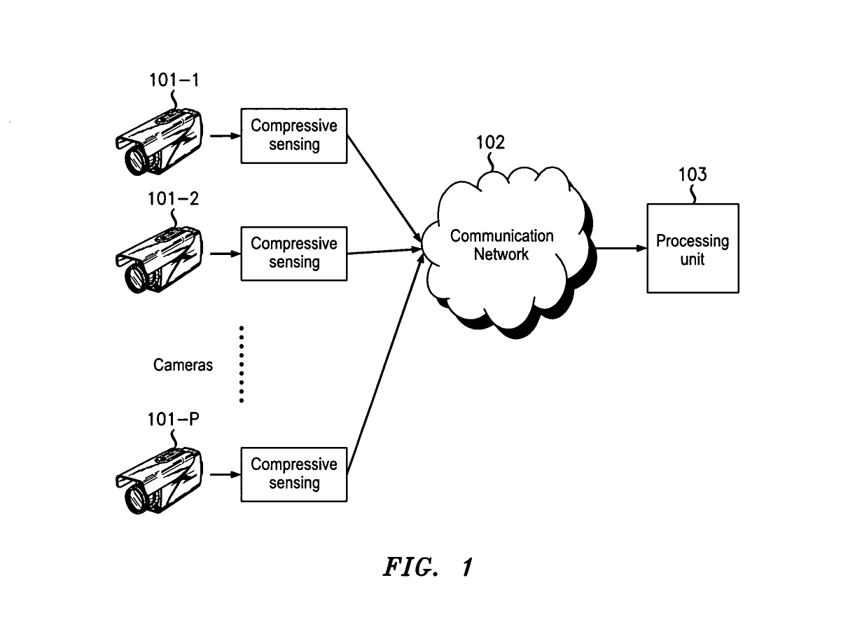

Example embodiments include a method and apparatus for detecting anomalies within compressive measurements representing segments of data. In at least one example embodiment, data is captured by devices, for example video cameras, in a communication network. However, example embodiments are not limited thereto. The overall network is further explained below with reference to FIG. 1. In one embodiment, the communication network may be a surveillance network. While embodiments are described with respect to surveillance video cameras, it will be understood that anomaly detection may be implemented with data taken from a variety of signals, such as, for example, audio signals from a microphone or array of microphones, still images, heat sensors, infrared cameras.

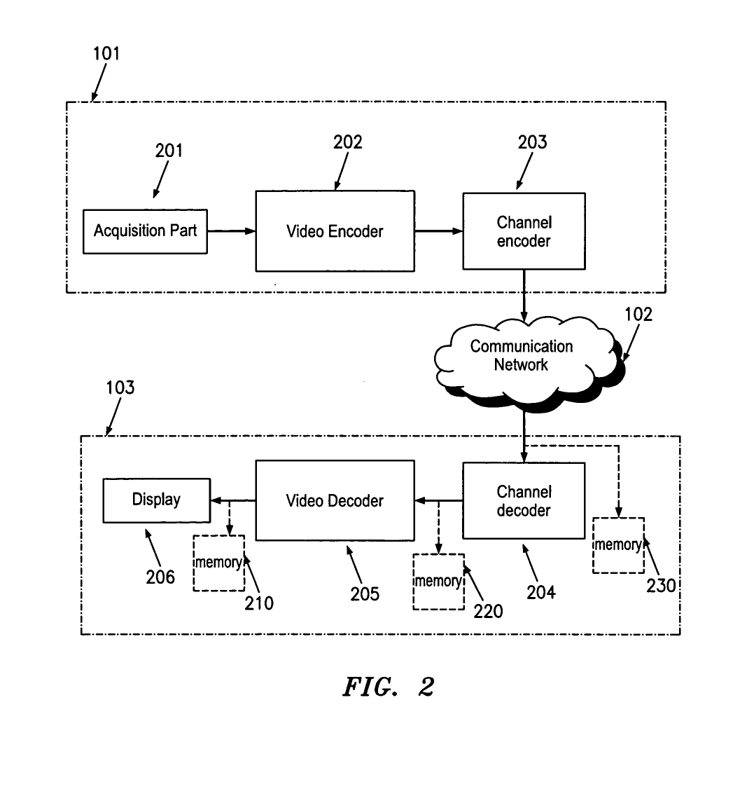

The communication network may include a camera assembly that encodes video data using compressive sensing, and transmits measurements that represent the acquired video data. The camera assembly may be stationary or movable, and the camera assembly may be operated continuously or in brief intervals which may be pre-scheduled or initiated on demand. The details of the camera assembly and the processing unit are further explained with reference to FIG. 2.

The video data includes a sequence of segments, known as frames, where each frame may be represented by a pixel vector having N pixel values. N is the number of pixels in a video volume, where a video volume includes a number of frames of the video. X(i,j,t) represents the value of a pixel at spatial location (i, j) in frame t. A camera assembly computes a set of M measurements Y (e.g., Y is a vector containing M values) on a per-volume basis for each frame by applying a sensing matrix (also known as a measurement matrix) to a frame of the video data, where M is less than N. The sensing matrix is a type of matrix having dimension M×N. In other words, the camera assembly generates measurements by applying the sensing matrix to the pixel vectors of the video data.

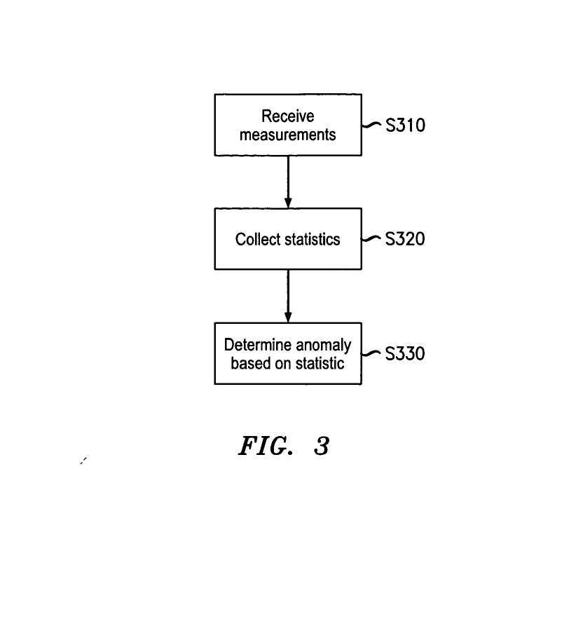

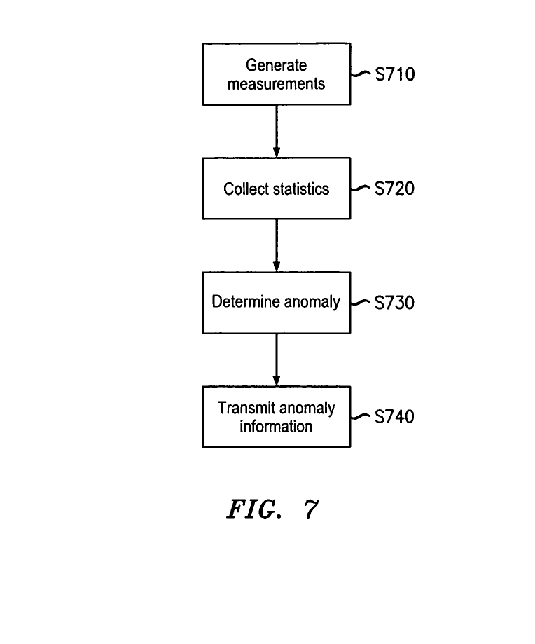

After receiving the measurements, in at least one embodiment, the processing unit may detect that an anomaly exists in segments of data, for example frames of video data, based on methods described with respect to FIG. 3. In at least another embodiment, the camera assembly does not send the measurements to the processing unit. In at least this example embodiment, the camera assembly detects that an anomaly exists in the video data based on methods described with respect to FIG. 7. In at least this example embodiment, the camera assembly transmits information concerning these anomalies to the processing unit.

FIG. 1 illustrates a communication network according to an embodiment. In one embodiment, the communication network may be a surveillance network. The communication network includes one or more camera assemblies 101 for acquiring, encoding and/or transmitting data such as video, audio and/or image data, a communication network 102, and at least one processing unit 103 for receiving, decoding and/or displaying the received data. The camera assemblies 101 may include one camera assembly or a first camera assembly 101-1 to P^{th} camera assembly 101-P, where P is any integer greater than or equal to two. The communication network 102 may be any known transmission, wireless or wired, network. For example, the communication network 102 may be a wireless network which includes a radio network controller (RNC), a base station (BS), or any other known component necessary for the transmission of data over the communication network 102 from one device to another device.

The camera assembly 101 may be any type of device capable of acquiring data and encoding the data for transmission via the communication network 102. Each camera assembly device 101 includes a camera for acquiring video data, at least one processor, a memory, and an application storing instructions to be carried out by the processor. The acquisition, encoding, transmitting or any other function of the camera assembly 101 may be controlled by the at least one processor. However, a number of separate processors may be provided to control a specific type of function or a number of functions of the camera assembly 101. The camera assembly is described in further detail with respect to FIG. 2.

The processing unit 103 may be any type of device capable of receiving, decoding and/or displaying data such as a personal computer system, mobile video phone, smart phones or any type of computing device that may receive data from the communication network 102. The receiving, decoding, and displaying or any other function of the processing unit 103 may be controlled by at least one processor. However, a number of separate processors may be provided to control a specific type of function or a number of functions of the processing unit 103.

FIG. 2 illustrates functional components of the camera assembly 101 and the processing unit 103 according to an embodiment. For example, the camera assembly 101 includes an acquisition part 201, a video encoder 202, and a channel encoder 203. In addition, the camera assembly 101 may include other components that are well known to one of ordinary skill in the art. For example, the camera assembly 101 may include a processor for detecting an anomaly in encoded video data. Referring to FIG. 2, in the case of video, the acquisition part 201 may acquire data from the video camera component included in the camera assembly 101 or connected to the camera assembly 101. The acquisition of data (video, audio and/or image) may be accomplished according to any well known methods. Although the below descriptions describes the encoding and decoding of video data, similar methods may be used for image data or audio data, or any other type of data that may be represented by a set of values.

The video encoder 202 encodes the acquired data using compressive sensing to generate measurements to be stored on a computer-readable medium such as an optical disk or internal storage unit or to be transmitted to the processing unit 103 via the communication network 102. Compressive sensing and generation of measurements based on compressive sensing are described in U.S. application Ser. No. 13/213,743 (“Method and Apparatus for Video Coding using a Special Class of Measurement Matrices,” filed Aug. 19, 2011), U.S. application Ser. No. 13/296,482 (“Method and Apparatus for Encoding/Decoding Data for Motion Detection in a Communication System,” filed Nov. 15, 2011), and U.S. application Ser. No. 13/328,149 (“Method and Apparatus for Object Detecting Using Compressive Sensing,” filed Dec. 16, 2011), all of which are incorporated herein by reference in their entirety. It is also possible to combine the functionality of the acquisition part 201 and the video encoder 202 into one unit. Also, it is noted that the acquisition part 201, the video encoder 202 and the channel encoder 203 may be implemented in one, two or any number of units. In example embodiments, the video encoder 202 may further detect anomalies in the generated measurements.

The channel encoder 203 codes or packetizes the measurements to be transmitted over the communication network 102 in at least one example embodiment. For example, the measurements may be processed to include parity bits for error protection, as is well known in the art, before they are transmitted or stored. Then, the channel encoder 203 may transmit the coded measurements to the processing unit 103 or store them in a storage unit. In a further example embodiment, the channel encoder codes or packetizes anomaly information generated by the video encoder 202.

The processing unit 103 includes a channel decoder 204, a video decoder 205, and optionally a video display 206. The processing unit 103 may include other components that are well known to one of ordinary skill in the art. The channel decoder 204 decodes the measurements received from the communication network 102 in at least one embodiment. For example, measurements are processed to detect and/or correct errors from the transmission by using the parity bits of the data. The correctly received packets are unpacketized to produce the quantized measurements generated in the video encoder 202. It is well known in the art that data can be packetized and coded in such a way that a received packet at the channel decoder 204 can be decoded, and after decoding the packet can be either corrected, free of transmission error, or the packet can be found to contain transmission errors that cannot be corrected, in which case the packet is considered to be lost. In other words, the channel decoder 204 is able to process a received packet to attempt to correct errors in the packet, to determine whether or not the processed packet has errors, and to forward only the correct measurements information from an error free packet to the video decoder 205. Measurements received from the communication network 102 may further be stored in a memory 230. The memory 230 may be a computer readable medium such as an optical disc or storage unit.

In at least one embodiment, the video decoder 205 receives the correctly received measurements and identifies anomalies in the video data. The video decoder 205 may receive transmitted measurements or receive measurements that have been stored on a computer readable medium such as an optical disc or storage unit 220.

The display 206 may be a video display screen of a particular size, for example. The display 206 may be included in the processing unit 103, or may be connected (wirelessly, wired) to the processing unit 103. The processing unit 103 displays the decoded video data on the display 206 of the processing unit 103. Also, it is noted that the display 206, the video decoder 205 and the channel decoder 204 may be implemented in one or any number of units. Furthermore, instead of the display 206, the processed data may be sent to another processing unit for further analysis, such as, determining whether the objects are persons, cars, etc. The processed data may also be stored in a memory 210. The memory 210 may be a computer-readable medium such as an optical disc or storage unit.

FIG. 3 illustrates a method of detecting anomalies in video data according to an embodiment.

In step S310, the video decoder 205 receives measurements Y that represent compressed coded segments of data. In at least one embodiment, the segments are frames of video data. As previously described, the measurements Y may be considered a vector having M measurements. The video x includes a number of frames, each of which has a number of pixels.

In step S320, in at least one embodiment, the video decoder 205 collects at least one statistic of the received measurements Y representing the video data. It will be understood by one of ordinary skill that statistics of the measurements and their distributions can be collected for nominal scenes in a surveillance video. When anomalies occur in the video, these anomalies also occur in compressive measurements of the video, and these anomalies in the measurements can be identified based on mathematical statistics computed or collected by the video decoder 205. In at least one example embodiment, the collected statistic is a variance value. However, other statistics may be used and are described with respect to other example embodiments below.

In one example embodiment, the video decoder 205 calculates a mathematical variance y(t) of the received measurements Y:

y(t)=var(Y(t)) (1)

where var(Y(t)) is the variance defined by

$$\begin{matrix}( 2 ) & \\ var ( Y ( t ) ) = \frac{1}{M} {\sum }_{m = 0}^{M - 1} {( {Y}_{m} ( t ) - μ ( t ) )}^{2} or \\ var ( Y ( t ) ) = \frac{1}{M - 1} {\sum }_{m = 0}^{M - 1} {( {Y}_{m} ( t ) - \overline{μ} ( t ) )}^{2} & ( 2 )\end{matrix}$$

where μ(t) is the true mean of Y(t) and μ̅(t) is the estimated mean given by:

$$\overline{μ} ( t ) = \frac{1}{M} {\sum }_{m = 0}^{M - 1} {Y}_{m} ( t ) \qquad ( 3 )$$

In another embodiment, the video decoder 205 calculates the variance of the difference of Y(t):

y(t)=var(Y(t)−Y(t−1))=var(Y(t))+var(Y(t−1))−2cov(Y(t),Y(t−1)) (4)

where

$$cov ( Y ( t ) ) = \frac{1}{M - 1} {\sum }_{m = 0}^{M - 1} ( {Y}_{m} ( t ) - \overline{μ} ( t ) ) ( {Y}_{m} ( t - 1 ) - \overline{μ} ( t - 1 ) ) \qquad ( 5 )$$

In step S330, in at least one example embodiment, the video decoder 205 identifies at least one anomaly based on the aforementioned variance statistic. As will be understood, when there is no anomaly in the surveillance video, y(t) remains relatively constant over time t. Such relatively constant values of y(t) are referred to hereinafter as nominal values of y(t).

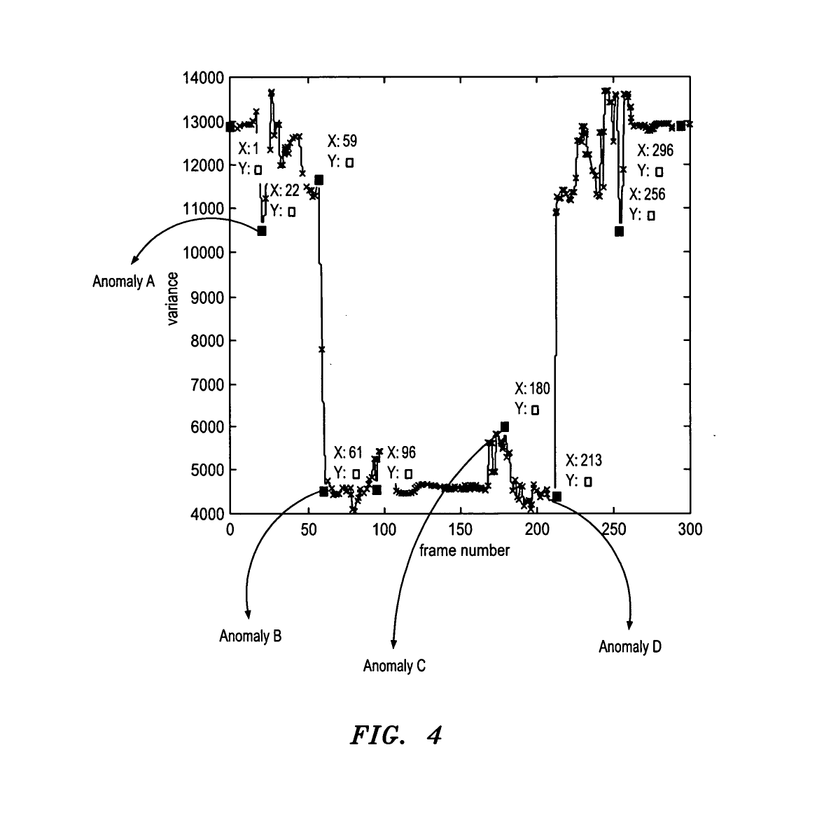

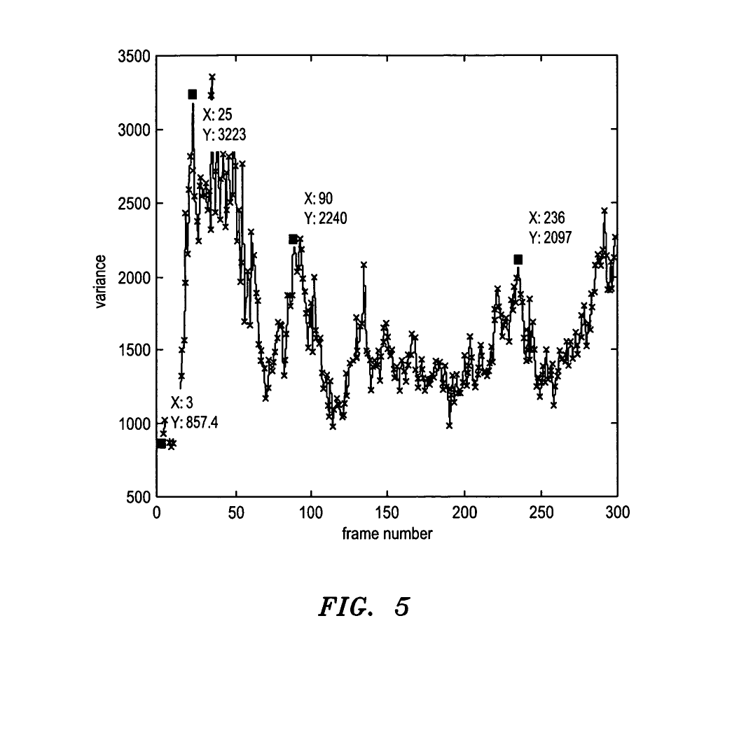

For example, when an anomaly occurs, for example, when an intruding object appears in the scene, at time t=tₐ, the value of y(tₐ) differs significantly (i.e., the values exhibit an upward or downward jump) relative to the nominal values of y(t). FIGS. 4-5 depict illustrative examples of at least one embodiment described above. The illustrative examples of FIGS. 4-5 show the variance of measurements changing from frame to frame, such that the horizontal axis is the frame number, i.e., the time index, and the vertical axis is the variance y(t) as defined in Eq. (1) or (4).

Referring to the illustrative example depicted in FIG. 4, consider the frames as being from a surveillance video of an office. At frame 1, the office is empty. At frame 22 (X=22), a person enters the office, and a change is seen in the variance. At frame 59, the person turns off the light and exits the office at frame 96. At frame 180, the person re-enters the office and turns on the light, and a change in variance is again seen. At frame 256-296, the person walks out of the office. As will be noted, there are large jumps in values of the variance when the lights are turned on and off (Anomaly A, Anomaly C), and when the person walks in and out of the office (Anomaly B and Anomaly D).

Referring to the illustrative example depicted in FIG. 5, the horizontal axis is the frame number, the time index, and the vertical axis is the variance y(t) as defined in Eq. (4). Consider the illustrative example of FIG. 5 as being data captured from a surveillance video of an office hall. At frame 3, the hall is empty so the variance value y(t) is relatively small. At frame 25, a first person walks into the hall, and a relatively large increase in variance is depicted. At frame 90, a second person walks into the hall, and at frame 236 the first person leaves the hall. As will be noted, changes in the variance of the measurements correlate to meaningful events in the video.

Referring again to FIG. 3, by examining the values of y(t), and identifying those values that are more than a threshold value different from values corresponding to adjacent frames, the video decoder 205 detects, in step S330, the anomalies of the surveillance video if the statistical variance corresponding to the set of measurements representing the frame differs by at least a threshold amount from a statistical variance of a set of measurements representing a frame adjacent to that frame. For example, as shown in the illustrative embodiments with reference to FIG. 4, an anomaly is seen at frame 61 because the variance value is very different from the variance value at frame 59.

In at least one embodiment, the variance statistic may be written as a normalized statistic. When y(t) according to Eq. (4) is used, the equation may be rewritten as

y(t)=[var(Y(t))+var(Y(t−1))][1−\tilde{ρ}(Y(t),Y(t−1))] (6)

where

$$\tilde{ρ} ( Y ( t ) , Y ( t - 1 ) ) = \frac{cov ( Y ( t ) , Y ( t - 1 ) )}{\frac{1}{2} [ var ( Y ( t ) ) + var ( Y ( t - 1 ) ) ]} \qquad ( 7 )$$

is an approximation to the correlation coefficient between Y(t) and Y(t−1).

The video decoder 205 may use the variance statistic y(t) in Eq. (6) as a normalized statistic such that when the value of y(t) falls below a threshold, the video decoder 205 may flag an alarm condition or anomaly.

Referring again to step S320 of FIG. 3, in at least one embodiment, the video decoder 205 may collect a different statistic, or a correlation statistic, of compressive measurements of the video data. The video decoder 205 collects a correlation statistic in order to identify an orientation of an image or a frame in at least one example embodiment.

As is known, orientation in an image is an identifiable feature. In surveillance, orientation may indicate a line of people moving in a particular direction. Further, when time is considered as a dimension of the video, the orientation of frames of the video can be used to derive the speed of motion of an object. Speed and direction of an object may be indications of an anomaly, for example, if an object is moving opposite to the direction of flow of other traffic, or if an object is moving relatively very fast or slow compared to surrounding traffic.

By using a circulant sensing matrix for computing compressive measurements, the video decoder 205 may detect orientation of a surveillance video directly from the measurements without reconstructing the pixels of the frame based on the measurements. This is possible because the measurements from a circulant sensing matrix preserve the relative position offset information in the source video. As is known, a circulant matrix is a special type of Toeplitz matrix, a Toeplitz matrix being a matrix in which each descending diagonal from left to right is constant. A circulant matrix is a Toeplitz matrix in which a row vector is rotated one element, or a number of elements, to the right or left relative to the preceding row vector. The purpose and use of a sensing matrix in the context of example embodiments was described previously.

In the context of example embodiments, a video contains a predominant orientation if values of the pixels are correlated along a certain direction. This correlation may be detected, for example, by examining the differences of pixels with proper horizontal and vertical offsets. Because of the circulant property of the sensing matrix, the measurements must also be correlated in the corresponding direction. The correlation may then be detected by examining the differences of measurements with proper offsets which correspond to the horizontal and vertical offsets of pixels in the original video mentioned above. By detecting the correlation of the measurements, the video decoder 205 detects the orientation in the source video, without reconstructing the video.

In an example embodiment, the video encoder 202 calculates compressive measurements using a circulant sensing matrix as the sensing matrix. The sensing matrix was described previously. The resultant measurements are arranged on at least a horizontal and vertical axis, with the axes representing one of a horizontal direction, a vertical direction, and a time dimension. The video decoder 205 then analyzes the correlation in the measurements in step S320. The analysis of the measurements provides a measure of the correlation along all directions of the image.

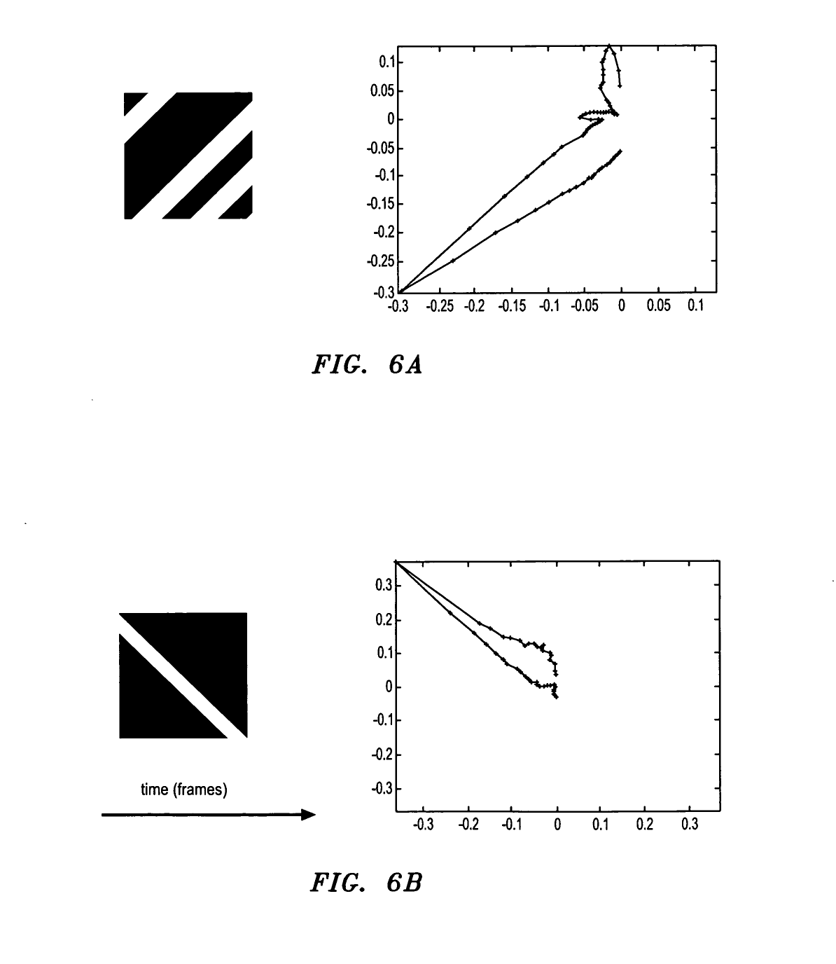

Illustrative examples of orientation of frames of video are shown in FIGS. 6A and 6B. Referring to FIG. 6A, an image consisting of stripes with a predominant orientation is shown on the left-hand side of the figure. As is shown in the right side of FIG. 6A, the correlation measurements being placed on horizontal direction and vertical direction axes) is highest along the direction that is the same as the orientation of the image. Therefore, an analysis of the measurements is able to detect the orientation of the image based on statistics of the measurements only. As shown in FIG. 6A, the correlation of the measurements is highest in the direction of 45 degrees, indicating that the image has the predominant orientation in 45 degrees.

As previously noted, measurements may be arranged in a measurement space using one of at least three dimensions on each axis. The measurements shown in FIG. 6A have been arranged on axes representing vertical and horizontal directions. However, a time dimension may also be utilized for an axis of the plot. An illustrative example of measurements placed on time and horizontal direction axes is depicted in FIG. 6B.

FIG. 6B illustrates that the speed of an object may be detected by analyzing measurements. In FIG. 6B, the image is made up of vertical lines in a sequence of frames. That is, the horizontal direction on the left side of FIG. 6B is the time dimension, comprised of different frames of a video. The vertical direction of the image is the same vertical line from different frames of the video. The image includes a white stripe with an angle of 135 degrees. This represents, for example, that a white object is moving from top to bottom with increasing frame numbers. In other words, the object is moving in the vertical direction with a negative speed. Effectively, when regarding this as an image, there is a predominant orientation in the image, and therefore, the analysis of the measurements shows the highest correlation in the direction of 135 degrees, as shown in the right side of FIG. 6B.

In example embodiments, therefore, the video decoder detects a predominant orientation in received measurements by arranging the measurements on an orientation curve. The horizontal and vertical axes of the orientation curve may correspond to the horizontal and vertical direction of a frame of the original video. In this case, the orientation of the curve represents the orientation of frames of the video.

In at least another example embodiment, the horizontal axis of the orientation curve may correspond to the time axis of the video, and the vertical axis may correspond to the vertical axis of a frame of the video. In this case, the slope of the curve indicates the speed of an object in the vertical direction in the video.

In at least another example embodiment, the horizontal axis of the orientation curve corresponds to the time axis of the video, and the vertical axis of the orientation curve corresponds to the horizontal axis of the frame of the video. In this case, the slope of the curve indicates the speed of an object in the horizontal direction of the video.

Referring again to Referring again to FIG. 3, in step S330, the video decoder 205 detects an anomaly based on the above-described orientation curve. In at least one example embodiment, the video decoder 205 identifies a slope of the orientation curve and determines a speed of a point based on the determined slope. The video decoder 205 then identifies an anomaly if the determined speed is greater than or less than a threshold. In a still further example embodiment, an anomaly is detected if a direction of motion of an object is opposite to the direction of motion of nearby objects.

In example embodiments for which compressive measurements represent data that includes still images, orientation may represent a physical anomaly of the image.

In example embodiments for which compressive measurements represent data that includes audio data captured by, for example, an array of microphones, changes in delay and amplitude among microphones indicate the position of sound sources. In at least these example embodiments, a slope of measurements indicates the direction and speed of sound sources.

In example embodiments for which compressive measurements represent data that includes audio data captured by, for example, a single microphone, movement of a sound source toward or away from the microphone results in an increase or decrease in pitch, and acceleration results in a continuous change of pitch. If the measurements are taken of a sonogram, which as is known is a time-frequency diagram of the sound, then the slope of the orientation curve will distinguish among sound sources that are stationary or moving at constant speed from those that accelerate or decelerate.

In at least another example embodiment, anomaly detection may be performed by the camera assembly 101, rather than by the video decoder 205. Because the computations and collection of statistics is relatively simplified, the computations and collection may be performed by a relatively less complex processor of a camera assembly 101, for example after the video encoder 202 of the camera assembly 101. The video encoder 202 makes the measurements, and the detection is performed at the camera by using the measurements. In at least this example embodiment, instead of transmitting compressed data to the centralized processor 103, the camera assembly 101 may transmit only anomaly information, in order to further reduce the amount of bandwidth required by the surveillance video cameras. In other example embodiments, the detection is performed by, for example, a still camera. In at least another example embodiment, the detection is performed by, for example, an array of microphones. In a still further example embodiment, the detection is performed by, for example, a single microphone.

Referring to FIG. 7, video encoder 202 generates compressive measurements in step S710, using a sensing matrix as described above. The sensing matrix may be a circulant matrix in one example embodiment.

In step S720, the video encoder collects statistics on the generated compressive measurements. Step S720 is the same or similar as the processing performed in step S320, described above, and the description is not repeated here. Similarly, in step S730, the video encoder 202 determines the presence of an anomaly based on the collected statistics. Step S730 includes the same or similarly processing as that performed in step S330, described above, and the description is not repeated here in the interest of brevity.

In step S740, the video encoder 202 transmits anomaly information through the communication network 102 to the processing unit 103. In at least one example embodiment, only anomaly information is transmitted, rather than all compressive sensing data, further reducing the amount of bandwidth required for communication from the video encoder 202 to the processing unit 103.

Example embodiments provide anomaly detection by using compressive measurements so that a reduced amount of data is required for reliable detection of anomalies. Embodiments further permit reduced bandwidth for data transmission and reduced complexity of surveillance cameras. Although example embodiments have been described with respect to video data, example embodiments are not limited thereto. On the contrary, the processing unit 103 may perform anomaly detection based on statistical analysis of compressive measurements taken from a variety of signals. Further, the video decoder 205 may be any other type of encoder capable of decoding a variety of signals. In at least one example embodiment, the processing unit 103 performs statistical analysis of compressive measurements taken from audio signals of a single microphone or an array of microphones.

In a further example embodiment, the processing unit 103 performs statistical analysis of compressive measurements taken from still images. In a still further example embodiment, the processing unit 103 performs statistical analysis of compressive measurements taken from a heat sensor or a network of heat sensors. In yet another example embodiment, the processing unit 103 performs statistical analysis of compressive measurements taken from an infrared camera or a network of infrared cameras. In at least these example embodiments, compressive measurements may be generated by performing weighted integrations directly on the analog signals generated by the sensing/acquisition devices, without additional steps of sampling and digitization of the raw input signal. For example embodiments using of video or still images, the measurements may be generated by weighted integrations in the optical domain. For example embodiments using audio signals, the weighted integrations may be done on the microphone output signal.

Because computations for anomaly detection in example embodiments are simplified, bandwidth may further be reduced by allowing computations to occur at the surveillance camera. Bandwidth may be reduced in that only anomaly data needs to be sent to a centralized system on the network. Network use by the surveillance cameras may thereby be reduced so that network capacity may be used for other applications.

Variations of the example embodiments are not to be regarded as a departure from the spirit and scope of the example embodiments, and all such variations as would be apparent to one skilled in the art are intended to be included within the scope of this disclosure.

1. A method comprising:
receiving sets of measurements, a set of measurements representing compressed coded data of a segment of data;
collecting at least one statistic of the sets of measurements; and
examining the at least one statistic to detect at least one anomaly in the at least one segment.

2. The method of claim 1, wherein the compressed coded data is generated by applying sensing matrices to a segment of video data.

3. The method of claim 1, wherein,
the collecting comprises determining statistical variances of the sets of measurements, and
the examining comprises identifying an anomaly in the at least one segment if the statistical variance corresponding to the set of measurements representing the at least one segment differs by at least a threshold amount from a statistical variance of a set of measurements representing a segment adjacent to the at least one segment.

4. The method of claim 2, further comprising:
determining a second statistic correlating (i) a variance of a set of measurements corresponding to a first segment or a first set of segments and (ii) a variance of a set of measurements corresponding to a second segment or a second set of segments, the second segment or second set of segments being prior in time to the first segment or the first set of segments, respectively; and
indicating an error condition if the second statistic falls below a threshold.

5. The method of claim 1, wherein,
the collecting comprises,
arranging the received sets of measurements as a curve on at least two axes such that a first axis of the at least two axes corresponds to one of three dimensions of the data and a second axis of the at least two axes corresponds to one of three dimensions of the data different from the dimension represented by the first axis, the three dimensions being a horizontal direction, a vertical direction, and time, and
determining a most likely orientation of the data in the measurement space based on statistical correlation values of the measurements, and the examining comprises,
identifying a slope of the curve,
determining a speed of the point based on the slope of the curve, and
identifying an anomaly if the determined speed is greater than or less than a threshold.

6. A method comprising:
compressing data into a set of encoded measurements;
collecting at least one statistic of the set of measurements; and
examining the at least one statistic to detect at least one anomaly.

7. The method of claim 6, wherein the compressing comprises:
applying sensing matrices to segments of pixels of video data.

8. The method of claim 6, further comprising:
transmitting a report of the detected at least one anomaly.

9. The method of claim 6, wherein,
the collecting comprises determining statistical variances of the sets of measurements, and
the examining comprises identifying an anomaly in the at least one segment if the statistical variance corresponding to the set of measurements representing the at least one segment differs by at least a threshold amount from a statistical variance of a set of measurements representing a segment adjacent to the at least one segment.

10. The method of claim 6, further comprising:
determining a second statistic correlating a variance of a set of measurements corresponding to a first segment or a first set of segments and a variance of a set of measurements corresponding to a second segment or a second set of segments, the second segment or second set of segments being prior in time to the first segment or the first set of segments, respectively; and
indicating an error condition if the second statistic falls below a threshold.

11. The method of claim 6, wherein,
the collecting comprises arranging the received sets of measurements as a curve on at least two axes such that a first axis of the at least two axes corresponds to one of three dimensions of the data and a second axis of the at least two axes corresponds to one of three dimensions of the data different from the dimension represented by the first axis, the three dimensions being a horizontal direction, a vertical direction, and time, and
determining a most likely orientation of the data in the measurement space based on statistical correlation values of the measurements, and
the examining comprises,
identifying a slope of the curve;
determining a speed of the point based on the slope of the curve; and
identifying an anomaly if the determined speed is greater than or less than a threshold.

12. An apparatus comprising:
a memory; and
a processor configured to,
receive sets of measurements, a set of measurements representing compressed coded data of at least one segment of data,
store the received sets of measurements in the memory,
collect at least one statistic of the sets of measurements, and
examine the at least one statistic to detect at least one anomaly in the at least one segment.

13. The apparatus of claim 12, wherein the compressed coded data is generated by applying sensing matrices to a segment of video data.

14. The apparatus of claim 12, wherein the processor is further configured to:
determine statistical variances of the sets of measurements; and
identify an anomaly in the at least one segment if the statistical variance corresponding to the set of measurements representing the at least one segment differs by at least a threshold amount from a statistical variance of a set of measurements representing a segment adjacent to the at least one segment.

15. The apparatus of claim 13, wherein the processor is further configured to:
determine a second statistic correlating (i) a variance of a set of measurements corresponding to a first segment or a first set of segments and (ii) a variance of a set of measurements corresponding to a second segment or a second set of segments, the second segment or second set of segments being prior in time to the first segment or the first set of segments, respectively; and
indicate an error condition if the second statistic falls below a threshold.

16. The apparatus of claim 13, wherein the processor is further configured to:
arrange the received sets of measurements as a curve on at least two axes such that a first axis of the at least two axes corresponds to one of three dimensions of the data and a second axis of the at least two axes corresponds to one of three dimensions of the data different from the dimension represented by the first axis, the three dimensions being a horizontal direction, a vertical direction, and time;
determine a most likely orientation of the data in the measurement space based on statistical correlation values of the measurements;
identify a slope of the curve;
determine a speed of a point in a frame based on a slope of the curve; and
identify an anomaly if the determined speed is greater than or less than a threshold.

17. An apparatus comprising:
a processor, the processor configured to,
compress first data into a set of encoded measurements,
collect at least one statistic of the set of measurements; and
examine the at least one statistic to detect at least one anomaly.

18. The apparatus of claim 17, wherein the processor is further configured to:
determine statistical variances of the sets of measurements; and
identify an anomaly in the at least one segment if the statistical variance corresponding to the set of measurements representing the at least one frame differs by at least a threshold amount from a statistical variance of a set of measurements representing a frame adjacent to the at least one frame.

19. The apparatus of claim 17, wherein the processor is further configured to:
determine a second statistic correlating a variance of a set of measurements corresponding to a first segment or a first set of segments and a variance of a set of measurements corresponding to a second segment or a second set of segments, the second segment or second set of segments being prior in time to the first segment or the first set of segments, respectively; and
indicate an error condition if the second statistic falls below a threshold.

20. The apparatus of claim 17, wherein the first data is video data and the processor is further configured to:
apply sensing matrices to a segment of video data;
arrange the received sets of measurements as a curve on at least two axes such that a first axis of the at least two axes corresponds to one of three dimensions of the first data and a second axis of the at least two axes corresponds to one of three dimensions of the first data different from the dimension represented by the first axis, the three dimensions being a horizontal direction, a vertical direction, and time;
determine a most likely orientation of the first data in the measurement spaced on statistical correlation values of the measurements;
identify a slope of the curve;
determine a speed of the point based on the slope of the curve; and
identify an anomaly if the determined speed is greater than or less than a threshold.
